(19) United States
(12) Patent Application Publication
(10) Pub. No.: US 2013/0019158 A1
(43) Pub. Date: Jan. 17, 2013

(54) INFORMATION PROCESSING APPARATUS, INFORMATION PROCESSING METHOD, AND STORAGE MEDIUM

(71) Applicant: Akira WATANABE, Tokyo (JP)

(72) Inventor: Akira WATANABE, Tokyo (JP)

(21) Appl. No.: 13/546,266

(22) Filed: Jul. 11, 2012

(30) Foreign Application Priority Data
Jul. 12, 2011 (JP) 2011-153405

(51) Int. Cl. G06F 17/21

(52) U.S. Cl. 715/230

(57) ABSTRACT

An editing mode is designated from among a plurality of editing modes available for input of handwriting. An executed position is acquired at a location on the display screen at which a particular handwriting operation is performed. A mode image, which represents the editing mode designated at a time the particular handwriting operation is performed, is temporarily displayed near the executed position.

### CROSS-REFERENCE TO RELATED APPLICATION

This application is based upon and claims the benefit of priority from Japanese Patent Application No. 2011-153405 filed on Jul. 12, 2011, of which the contents are incorporated herein by reference.

### BACKGROUND OF THE INVENTION

1. Field of the Invention

The present invention relates to an information processing apparatus, an information processing method, and a storage medium.

2. Description of the Related Art

Recently, information processing apparatus having a display unit for displaying images on a display screen and a handwriting input unit for adding annotative information concerning images based on handwritten information input through the display screen have been in widespread use. Various techniques have been proposed in the art for improving operation of user interfaces.

Japanese Laid-Open Patent Publication No. 2003-248544 discloses a display method, which places an operation window at all times in a peripheral position of a main window. Since the operation window is in the peripheral position of the main window, the operator is not required to shift his or her gaze a large distance toward and away from the operation window while performing operations using the display unit, and therefore better operation is facilitated.

Japanese Laid-Open Patent Publication No. 2009-025861 proposes a panel operating system in which, when a stylus pen touches an area on an operation panel, a selection that was made immediately before the stylus pen touched the operation panel is called up and displayed at the touched area, in response to turning on a switch on the stylus pen. The disclosed panel operating system makes it possible to reduce the range within which the stylus pen is moved.

### SUMMARY OF THE INVENTION

If an information processing apparatus has a display screen having a large display area in a range from B5 size to A4 size on which an image is to be displayed substantially fully over the display screen, then the display method and the panel operating system disclosed in Japanese Laid-Open Patent Publication No. 2003-248544 and Japanese Laid-Open Patent Publication No. 2009-025861 pose certain problems, as described below.

During editing of an image displayed on the display screen in a presently designated editing mode, it is possible for the user to focus too much attention on the editing process itself, and thus fail to remember the editing mode. If the user forgets the editing mode and wishes to know the editing mode, then the user looks at the editing mode icon, which is displayed on the display screen, confirms the editing mode type, and then continues to edit the image in the designated editing mode. At this time, since the user is required to avert his or her eyes from the handwriting spot on the display screen in order to confirm the editing mode icon, subsequently, the user may not be able to quickly recall the position of the handwriting spot, or time may be consumed in identifying the position of the handwriting spot. In other words, the user must keep the last handwriting spot as well as the type of the presently designated editing mode in mind at all times for immediate retrieval, and thus, the user cannot dedicate sufficient attention to the editing process.

It is an object of the present invention to provide an information processing apparatus, an information processing method, and a storage medium, which allow a user to easily confirm the type of a presently designated editing mode, without looking away from a handwriting spot on a display screen.

According to the present invention, there is provided an information processing apparatus having a display unit for displaying an image on a display screen, and a handwriting input unit for adding annotative information concerning the image based on a handwritten input applied through the display screen, comprising an editing mode designator for designating an editing mode from among a plurality of editing modes available for the handwritten input, an executed position acquirer for acquiring an executed position on the display screen at which a particular handwriting operation is performed, and a visual effect adder for adding a visual effect, which is temporarily displayed near the executed position acquired by the executed position acquirer, wherein the visual effect is added to a mode image representing the editing mode designated by the editing mode designator at a time that the particular handwriting operation is performed.

As described above, the information processing apparatus includes the visual effect adder for adding a visual effect, which is temporarily displayed near the executed position, and wherein the visual effect is added to a mode image representing the editing mode designated at a time that the particular handwriting operation is performed. Consequently, upon the particular handwriting operation being performed, the mode image is called up and displayed. The user can easily confirm the type of the presently designated editing mode, without looking away from a handwriting spot on the display screen. The mode image, which is temporarily displayed near the executed position, does not present an obstacle to an editing process performed on the display screen by the user of the information processing apparatus.

The image processing apparatus preferably further comprises a particular operation detector for detecting the particular handwriting operation.

Upon display of an icon on the display screen for designating the editing mode, preferably, the particular operation detector effectively detects the particular handwriting operation within a region of the display screen from which the icon is excluded.

The visual effect adder preferably adds the visual effect in order to change a displayed position of the mode image depending on a dominant hand of the user of the image processing apparatus.

The particular handwriting operation preferably comprises any one of a single tap, a double tap, and a long tap.

The mode image preferably includes a function to call in a pallet associated with the editing modes.

The mode image preferably comprises an image that is identical to or similar to an icon associated with the editing modes.

The mode image preferably comprises an image that includes character information concerning a designated editing mode.

The image processing apparatus preferably functions to enable proofreading of the image.

According to the present invention, there is also provided an information processing method adapted to be carried out by an apparatus having a display unit for displaying an image on a display screen, and a handwriting input unit for adding annotative information concerning the image based on a handwritten input applied through the display screen, comprising the steps of designating an editing mode from among a plurality of editing modes available for the handwritten input, acquiring an executed position on the display screen at which a particular handwriting operation is performed, and temporarily displaying, near the acquired executed position, a mode image representing the editing mode designated at a time that the particular handwriting operation is performed.

According to the present invention, there is further provided a storage medium storing a program therein, the program enabling an apparatus having a display unit for displaying an image on a display screen, and a handwriting input unit for adding annotative information concerning the image based on a handwritten input applied through the display screen, to function as an editing mode designator for designating an editing mode from among a plurality of editing modes available for the handwritten input, an executed position acquirer for acquiring an executed position on the display screen at which a particular handwriting operation is performed, and a visual effect adder for adding a visual effect, which is temporarily displayed near the executed position acquired by the executed position acquirer, wherein the visual effect is added to a mode image representing the editing mode designated by the editing mode designator at a time that the particular handwriting operation is performed.

With the information processing apparatus, the information processing method, and the storage medium according to the present invention, since a mode image representing the editing mode designated at a time that the particular handwriting operation is performed is temporarily displayed near the executed position, the mode image is called up and displayed at the time that the particular handwriting operation is performed. Therefore, the user can easily confirm the type of the presently designated editing mode, without looking away from a handwriting spot on the display screen. The mode image is temporarily displayed near the executed position and thus does not present an obstacle to an editing process performed on the display screen by the user of the information processing apparatus.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a front elevational view of an information processing apparatus according to an embodiment of the present invention;

FIG. 2 is a functional block diagram of the information processing apparatus shown in FIG. 1;

FIG. 3 is a flowchart of an operation sequence performed by the information processing apparatus shown in FIG. 1;

FIGS. 4A and 4B are front elevational views showing a display screen transition, which enables the user to recall an editing mode;

FIGS. 5A and 5B are front elevational views showing a display screen transition, which enables the user to recall an editing mode;

FIG. 6 is a front elevational view showing a display screen, which enables the user to recall an editing mode according to a first modification; and

FIG. 7 is a front elevational view showing a display screen, which enables the user to recall an editing mode according to a second modification.

### DESCRIPTION OF THE PREFERRED EMBODIMENTS

Information processing methods according to preferred embodiments of the present invention in relation to information processing apparatus for carrying out the information processing methods will be described below with reference to the accompanying drawings.

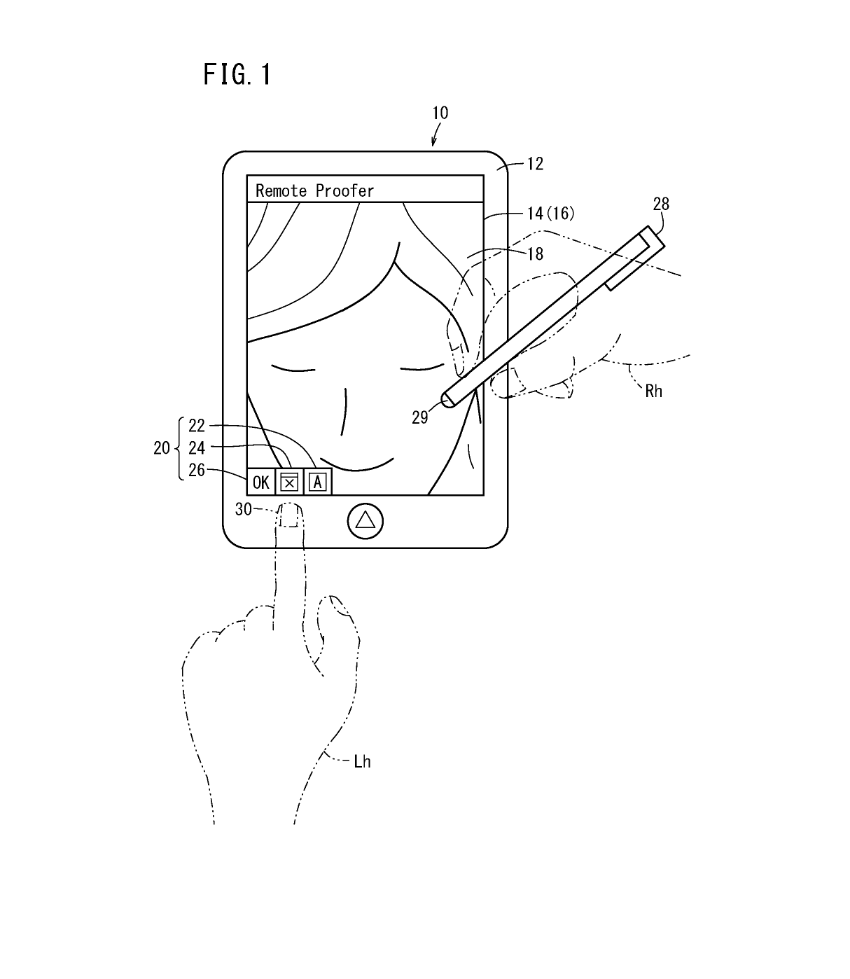

FIG. 1 shows in front elevation an information processing apparatus 10 according to an embodiment of the present invention.

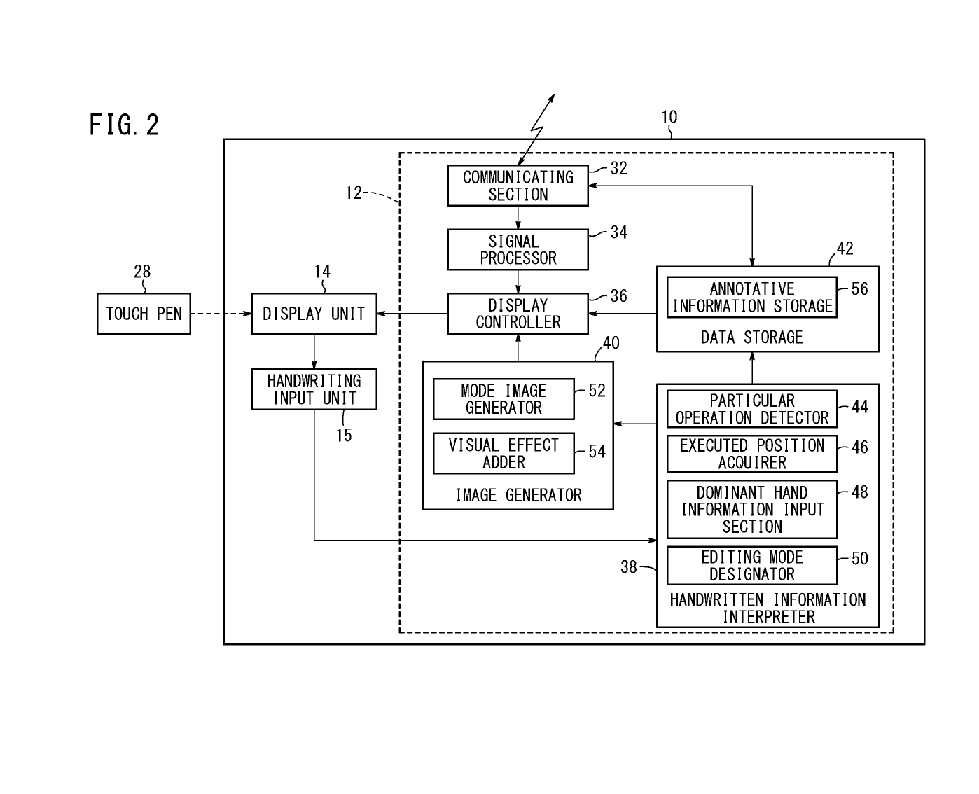

As shown in FIG. 1, the information processing apparatus 10 includes a main body 12 having a substantially rectangular shape, a display unit 14 disposed on a surface of the main body 12 and having an area occupying substantially the entire area of the surface of the main body 12, and a handwriting input unit 15 (see FIG. 2) for inputting handwritten information by detecting a spot of contact with the display unit 14. The spot of contact with the display unit 14 may be in the shape of a dot, a line, or any other region.

The display unit 14 includes a display screen 16, which displays a proof image 18. In FIG. 1, the proof image 18 represents the face of a woman as viewed in front elevation. The display screen 16 also displays icons 20 in a lower left corner thereof in overlapping relation to the proof image 18. The icons 20 include a first icon 22 for changing editing modes depending on the number of times that the first icon 22 is touched, a second icon 24 for switching between a handwriting mode and an erasing mode, and a third icon 26 for indicating the end of a proofreading process and for saving settings. If the user of the information processing apparatus 10 touches the first icon 22 a given number of times, for example, an annotating mode is selected. On the other hand, if the user touches the second icon 24 a given number of times, a handwriting mode is selected.

The information processing apparatus 10 may be used for various purposes and for various applications. For proofreading an image, the user is required to view the display screen 16 thoroughly in its entirety in order to confirm the proof image 18 efficiently. The information processing apparatus 10 is highly effective at proofreading images.

For performing a proofreading process using the information processing apparatus 10, the display unit 14, i.e., the display screen 16, preferably has a large display area, for example, in the range from B5 size to A4 size, in order for the user to view the display screen 16 in its entirety while minimizing the number of times that the user is required to perform operations on the information processing apparatus 10. In order for the user to operate quickly and efficiently using the information processing apparatus 10, the user occasionally uses not only a dominant hand (e.g., the right hand Rh), but also both hands (the right hand Rh and the left hand Lh). More specifically, the user grips a touch pen 28 (stylus) with the right hand Rh as the dominant hand, and moves the touch pen 28 such that a tip end 29 thereof traces across the display screen 16 to input handwritten information. The user also touches one of the icons 20 with a fingertip 30 of the left hand Lh so as to switch between the handwriting mode and the erasing mode, for example.

FIG. 2 is a functional block diagram illustrating the information processing apparatus 10 shown in FIG. 1. The information processing apparatus 10 includes functions that can be performed by a non-illustrated controller including a CPU, etc. The controller reads a program stored in a storage medium, e.g., a data storage unit 42 to be described later, such as a ROM, a RAM, or the like, and executes the program.

As shown in FIG. 2, the main body 12 includes a communication section 32 for sending electric signals to and receiving electric signals from an external apparatus, a signal processor 34 for processing proof data (i.e., image data representing the proof image 18 received from the communication section 32) in order to display the proof data, a display controller 36 for generating a display control signal from the proof data processed by the signal processor 34 and controlling the display unit 14 to display an image, including the proof image 18 together with annotative information based on the display control signal, a handwritten information interpreter 38 for interpreting handwritten information, which includes mode switching instructions and annotative information, based on the features of handwritten inputs from the handwriting input unit 15, an image generator 40 for generating display images including figures, symbols, icons, etc., depending on the handwritten information interpreted by the handwritten information interpreter 38, and a data storage unit 42 for storing the handwritten information interpreted by the handwritten information interpreter 38.

The annotative information includes image information representing characters, figures, symbols, patterns, hues, or combinations thereof, text information representing combinations of character codes such as ASCII (American Standard Code for Information Interchange) characters, speech information, and video information, etc.

The display unit 14 displays an image, including the proof image 18 and annotative information, based on a display control signal generated by the display controller 36. The display unit 14 comprises a display module capable of displaying color images. The display unit 14 may be a liquid crystal panel, an organic EL (electroluminescence) panel, an inorganic EL panel, or the like.

The handwriting input unit 15 comprises a touch panel detector, which is capable of detecting and inputting handwritten data directly through the display unit 14. The touch panel detector is capable of detecting handwritten data based on any of various detecting principles, for example, by using a resistance film, electrostatic capacitance, infrared radiation, electromagnetic induction, electrostatic coupling, or the like.

The signal processor 34 performs various types of signal processing, including an image scaling process, a trimming process, a color matching process based on ICC profiles, an image encoding process, an image decoding process, etc.

The handwritten information interpreter 38 includes, in addition to the function to interpret annotative information input to the handwritten information interpreter 38, a particular operation detector 44 for detecting particular handwritten operations, an executed position acquirer 46 for acquiring a position on the display screen 16 at which a particular operation has been executed (hereinafter referred to as an “executed position”), a dominant hand information input section 48 for inputting information concerning the dominant hand of the user (hereinafter referred to as “dominant information”), and an editing mode designator 50 for designating one of a plurality of editing modes (hereinafter referred to as a “designated mode”).

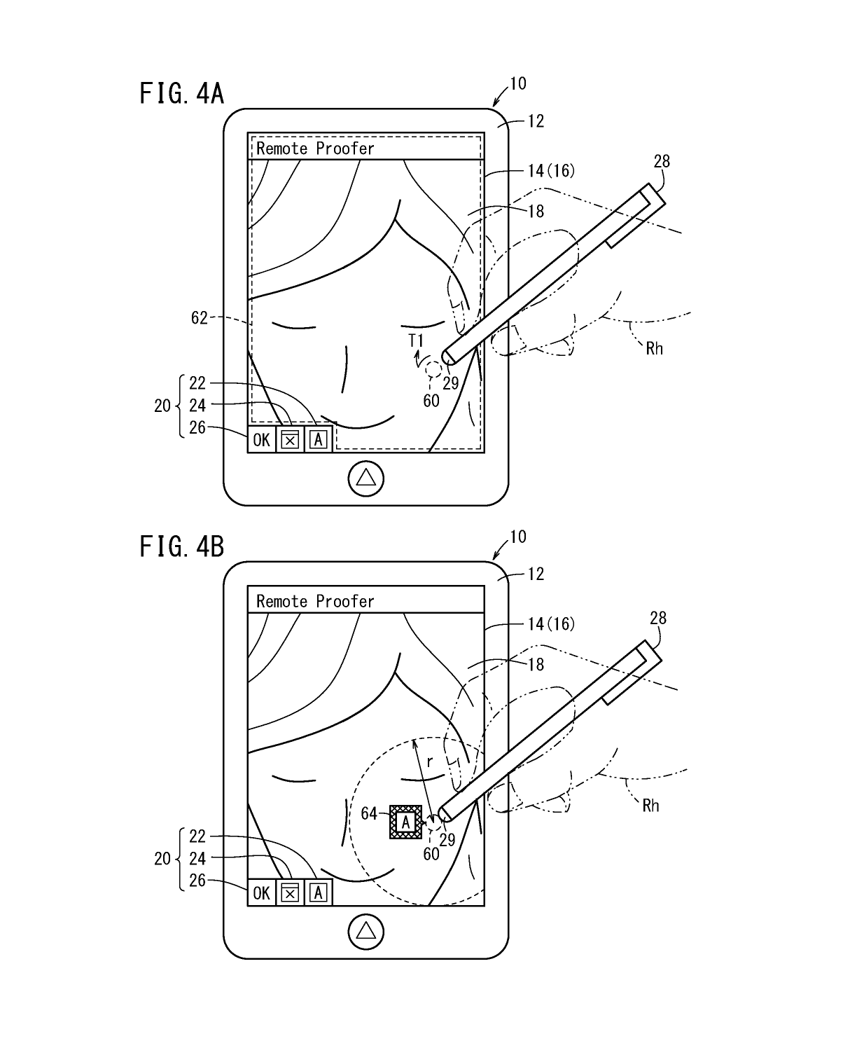

The image generator 40 includes, in addition to the function to generate display images including figures, symbols, icons, etc., depending on the handwritten information, a mode image generator 52 for generating a mode image 64 (see FIG. 4B) representative of a designated mode, and a visual effect adder 54 for adding a visual effect to the mode image 64 generated by the mode image generator 52.

The data storage unit 42, which comprises a memory such as a RAM or the like, includes, in addition to the function to store various data required for performing the information processing method according to the present invention, an annotative information storage unit 56 for storing annotative information together with temporary data.

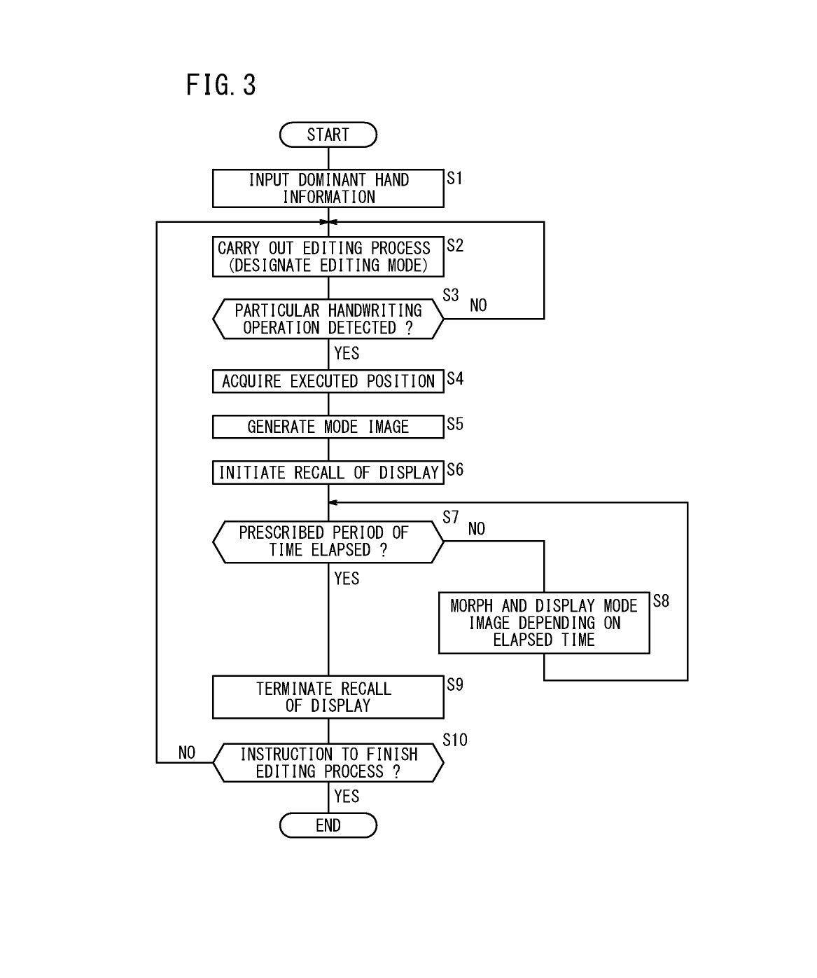

The information processing apparatus 10 according to the present embodiment is basically constructed as described above. Operations of the information processing apparatus 10 will be described below, mainly with reference to the flowchart shown in FIG. 3 and the functional block diagram shown in FIG. 2.

First, in step S1, dominant hand information of the user is input through the dominant hand information input section 48. More specifically, the dominant hand information input section 48 inputs the dominant hand information based on a manual operation made by the user via a non-illustrated setting screen. In the following discussion, it shall be assumed that the dominant hand information input section 48 inputs dominant hand information indicating that the dominant hand of the user is the right hand Rh.

Alternatively, the dominant hand information input section 48 may be capable of detecting the dominant hand of the user based on the tendency of touches made by the user. For example, the handwriting input unit 15 may detect a region of contact between the fingertip 30 and the display unit 14 where the display unit 14 is touched by the user's fingertip 30 continuously for a certain period of time or more. For example, if the user's fingertip 30 belongs to the left hand Lh, the area of contact usually is closer to a longer lefthand side of the display screen 16. In this case, the dominant hand information input section 48 judges a side opposite to the longer lefthand side of the display screen 16, i.e., the longer righthand side, as indicating the dominant hand of the user.

Then, in step S2, the user carries out an editing process on the proof image 18. Each time that the user carries out an editing process, the user indicates an editing mode suitable for a process of adding annotative information. More specifically, in response to the user touching one of the icons 20, and in particular the first icon 22, the editing mode designator 50 designates one of a plurality of editing modes available for inputting handwritten data. It is assumed that the first icon 22 (see FIG. 1) indicated by the alphabetical letter “A” is selected, designating a “text input mode” for inputting text information.

Available editing modes include at least one of an input mode for adding annotative information in various forms, a format mode for setting a format for added annotative information, and a delete mode (erasing mode) for deleting all or part of the added annotative information. Specific examples of input modes include various modes for inputting text, pen-written characters, rectangles, circles, lines, marks, speech, etc. Specific examples of format modes include various modes for setting colors (lines, frames, filling-in, etc.), line types (solid lines, broken lines, etc.), and auxiliary codes (underlines, frame lines).

It is possible that the user may focus too much attention to the editing process for editing the proof image 18, to such an extent that the designated mode may slip from the user's memory. According to the present invention, as shown in FIG. 4A, the user makes a single tap (indicative of a particular handwriting operation) along a path indicated by the arrow T1, at a position 60 (hereinafter referred to as an “executed position 60”) near the tip end 29 of the touch pen 28, without viewing the position of the icons 20 at the lower left corner of the display screen 16.

In step S3, the particular operation detector 44 judges whether or not the user has performed a particular handwriting operation. The particular handwriting operation may be a single tap, a double tap, three or more successive taps, a long tap, or the like. Such examples of the particular handwriting operation preferably are different from a handwriting operation, which typically is performed in the editing process, and such examples should also be distinguishable from each other in order to prevent any given handwriting operation from being detected in error.

The line of sight of the user may not necessarily be directed toward a substantially central region of the display screen 16. Therefore, it is preferable for the particular operation detector 44 to effectively detect the particular handwriting operation made on the display screen 16 substantially in its entirety. More specifically, the particular operation detector 44 may judge whether or not a single tap, for example, is made within a region (detectable region 62) of the display screen 16 from which the icons 20 are excluded.

In step S3, if the particular operation detector 44 determines that the user has not yet performed the particular handwriting operation (step S3: NO), then step S2 is executed repeatedly until it is determined that the particular handwriting operation has been performed.

If the particular operation detector 44 determines in step S3 that the user has performed the particular handwriting operation (step S3: YES), then control proceeds to step S4.

In step S4, the executed position acquirer 46 acquires the executed position 60 at which the particular handwriting operation has been performed, which was detected in step S3. More specifically, the executed position acquirer 46 acquires two-dimensional coordinates of the executed position from the handwriting input unit 15.

Then, in step S5, the mode image generator 52 generates a mode image 64 representative of the designated mode, which was designated in step S2. More specifically, the mode image generator 52 acquires from the editing mode designator 50 the type of designated mode at the time that the particular handwriting operation is detected. In FIG. 4A, the mode image generator 52 acquires information indicating that the designated mode is the text input mode. Then, the mode image generator 52 generates a mode image 64 representative of the text input mode. The mode image generator 52 may generate a mode image 64, or may read data of a mode image 64 stored in the data storage unit 42, each time that step S5 is executed.

Then, in step S6, the display unit 14 starts to recall display of the mode image 64. The term “recall display” means displaying the mode image 64 at a suitable time for the purpose of letting the user recall the present designated mode. The image generator 40 supplies a mode image 64 as an initial image to the display controller 36, which controls the display unit 14 in order to display the mode image 64.

As shown in FIG. 4B, the mode image 64, which is of the same form as the first icon 22, is displayed near the executed position 60 in overlapping relation to the proof image 18. The user can thereby visually recognize the mode image 64 without looking away from the tip end 29 of the touch pen 28. In other words, the user can envisage and recall the present designated mode (text input mode in FIG. 4A) from the form of the mode image 64. A mode image 64, which is identical or similar to the first icon 22, is preferable because it allows the user to easily envisage the type of the designated editing mode.

In FIG. 4B, the periphery of the executed position 60 is indicated as a circular region having a radius r. The radius r preferably is in a range from 0 to 100 mm, and more preferably, is in a range from 10 to 50 mm.

The mode image 64 is positioned on a left side of the executed position 60, which is opposite to the side corresponding to the dominant hand, i.e., the right hand Rh, of the user. Accordingly, the user visually recognizes the displayed mode image 64 clearly, since the image is not hidden behind the right hand Rh. For the same reason, the mode image 64 may be positioned on an upper or lower side of the executed position 60, or stated otherwise, on any side of the executed position except the side corresponding to the dominant hand.

Then, in step S7, the image generator 40 judges whether or not a prescribed period of time has elapsed from the start of the recall display procedure. Although the prescribed period of time is optional, preferably, the prescribed period is set to a time that is not stressful to the user, and is generally in a range from 0.5 to 3 seconds.

In step S7, if the image generator 40 determines that the prescribed period of time has not yet elapsed (step S7: NO), then the main body 12 morphs the mode image 64 and displays a morphed mode image 64 depending on the elapsed time in step S8. More specifically, the main body 12 repeats a process of morphing the mode image 64, which is carried out by the image generator 40, and a process of displaying the morphed mode image 64, which is carried out by the display controller 36.

The visual effect adder 54 adds a visual effect to the mode image 64. Such a visual effect refers to a general effect, which visually attracts the attention of the user by morphing the displayed image over time. Examples of suitable visual effects include, but are not necessarily limited to, fading-out, popping-up, scrolling, zooming in/out, etc. A fading-out effect will be described below by way of example.

As shown in FIG. 4B, the mode image 64 is displayed continuously until 1 second elapses from the start of the recall display procedure. The mode image 64 is an image that exhibits no transmittance or is extremely low in transmittance. Therefore, in the region at which the mode image 64 is positioned, the user can only see the character “A”, but cannot see the proof image 18.

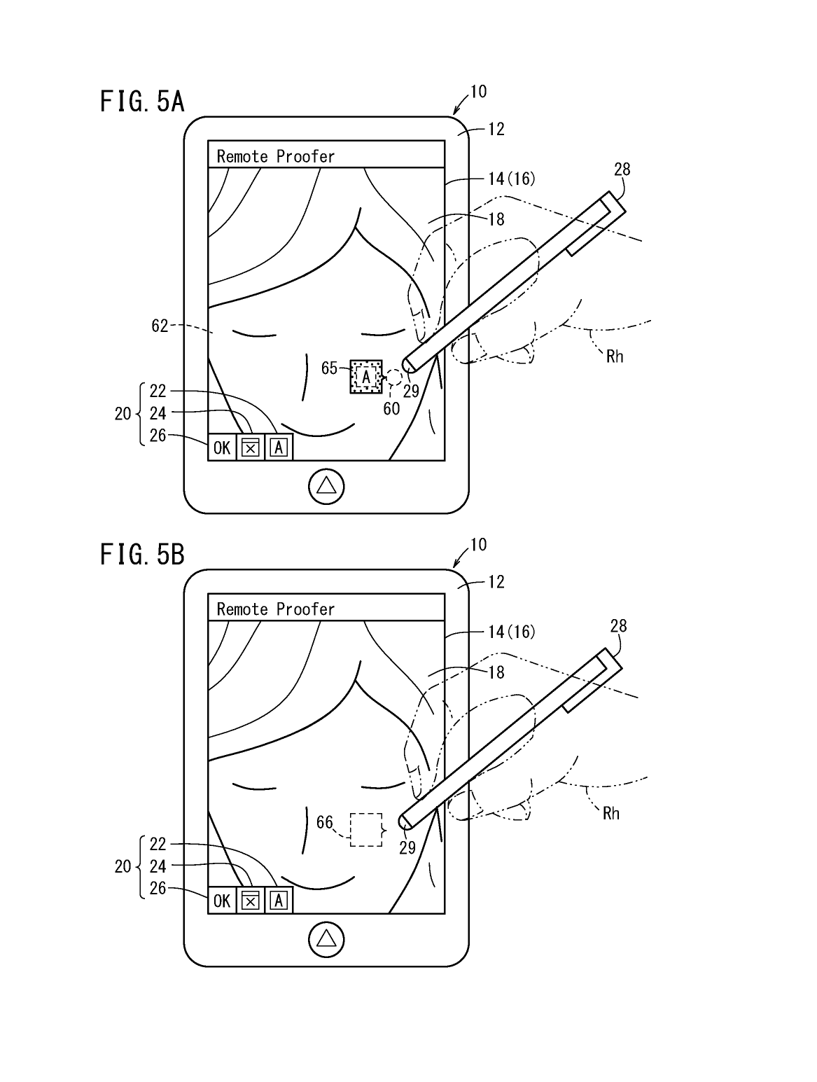

As shown in FIG. 5A, another mode image 65 is displayed continuously for a period of time after 1 second from the start of the recall display procedure and until 2 seconds have elapsed. The mode image 65 is an image of higher transmittance than the mode image 64. Therefore, in the region at which the mode image 64 is positioned, the user can see both the character “A” as well as the proof image 18.

As shown in FIG. 5B, yet another mode image 66, which is characterized by no image being displayed, occurs after 2 seconds from the start of the recall display process. In the region at which the mode image 66 is positioned, the user can see only the proof image 18, but not the character

In other words, the transmittance of the mode image 64 is gradually increased, i.e., the mode image changes from the mode image 64 to the mode image 65, and then from the mode image 65 to the mode image 66, as time passes from the start of the recall display procedure. In this manner, the elimination of the mode image 64, which signifies the end of the recall display procedure, is appealing to the eyes of the user.

In step S7, if the image generator 40 determines that the prescribed period of time has elapsed (step S7: YES), then control returns to step S9, whereupon the display unit 14 stops displaying the mode images 64, 65, 66.

Rather than based on whether or not the prescribed period of time has elapsed, the image generator 40 may end the recall display procedure based on whether or not the user has performed another handwriting operation. For example, the image generator 40 may end the recall display procedure if the handwritten information interpreter 38 determines that the touch pen 28 has left, i.e., has been drawn away from, the display screen 16. Such an alternative technique is preferable, because it allows the user to freely determine the timing at which the displayed mode image 64 is eliminated.

Finally, in step S10, the handwritten information interpreter 38 judges whether or not there is an instruction to finish the editing process. If the handwritten information interpreter 38 determines that there is no instruction to finish the editing process, then control returns to step S2, thereby repeating steps S2 through S10. If the handwritten information interpreter 38 determines that there is an instruction to finish the editing process, then the main body 12 brings the editing process to an end.

As described above, the image generator 40 includes the visual effect adder 54, which adds a visual effect for temporarily displaying, near the executed position 60, the mode image 64, which represents an editing mode designated at the time that a particular handwriting operation is performed. Accordingly, the mode image 64 can be called up and displayed upon performance of the particular handwriting operation. The user can easily confirm the type of editing mode presently designated, without being required to look away from the spot where the handwritten data are input. The mode image 64, which is displayed near the executed position 60, does not present an obstacle to the editing process.

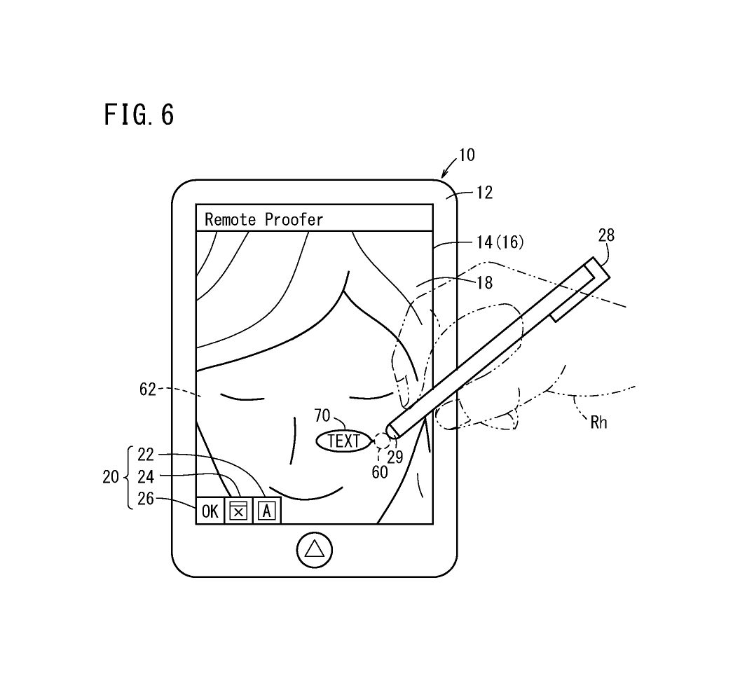

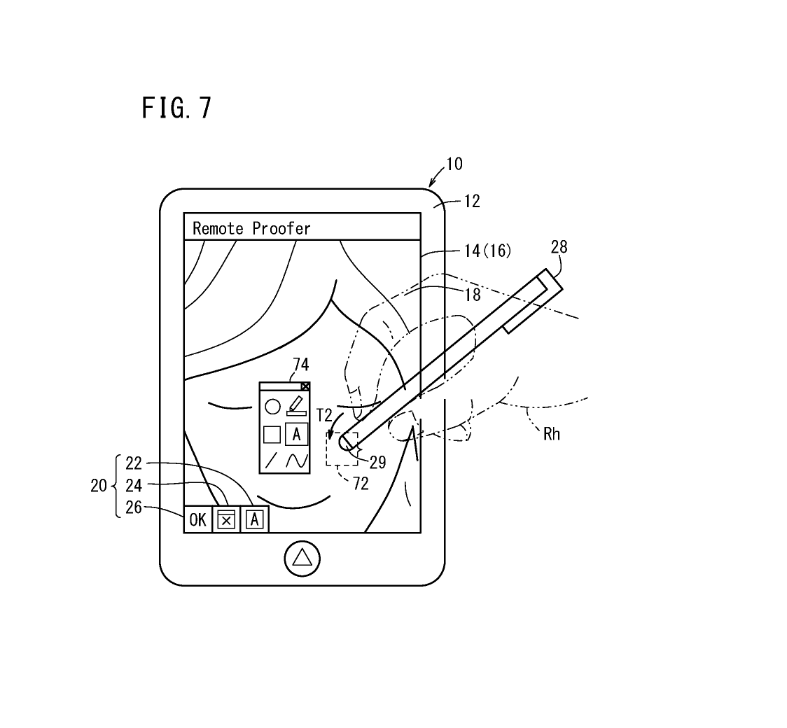

Modifications, and more specifically a first modification and a second modification, of the information processing method according to the present embodiment will be described below with reference to FIGS. 6 and 7. Parts of such modifications, which are identical to those of the above embodiment, are denoted by identical reference characters, and such features will not be described in detail below.

According to the first modification, as shown in FIG. 6, a mode image 70 is displayed, which differs in form from the mode image 64 (FIG. 4B) according to the aforementioned embodiment.

As shown in FIG. 6, a mode image 70 indicated by the letters “TEXT” is positioned on the display screen 16 near the executed position 60. The mode image 70, which includes character information concerning the editing mode, is displayed temporarily in order to provide the same advantages as those of the aforementioned embodiment. Therefore, the mode image 70 may be of any type, insofar as the mode image 70 allows the user to directly or indirectly envisage the type (attribute) of the editing mode that is designated at the present time.

According to the second modification, a mode image 72, which is used to initiate the recall display procedure, has a new function, which differs from the mode image 64 (FIG. 4B) according to the above embodiment. While the mode image 64 shown in FIG. 4B is displayed, if the user touches the display screen 16 with the touch pen 28 along a path indicated by the arrow T2 (see FIG. 7) near the mode image 64, then the display screen 16 changes in the following manner.

As shown in FIG. 7, the mode image 72 is not displayed, i.e., the mode image 72 is eliminated, and a rectangular handwriting pallet 74 is displayed on a left hand side of the eliminated mode image 72. The handwriting pallet 74 includes a group of icons representing a plurality of editing modes (six editing modes in the illustrated example), whereby the user can designate an alternative editing mode using the handwriting pallet 74.

In this manner, the handwriting pallet 74 may be called up in response to display of the mode image 64 (see FIG. 4B). Thus, the mode image 64 doubles in function in order to call up the handwriting pallet 74 for designating an editing mode. Therefore, the user can change editing modes at will, without looking away from the tip end 29 of the touch pen 28.

Although certain preferred embodiments of the present invention have been shown and described in detail, it should be understood that various changes and modifications may be made to the embodiments without departing from the scope of the invention as set forth in the appended claims.

What is claimed is:

1. An information processing apparatus having a display unit for displaying an image on a display screen, and a handwriting input unit for adding annotative information concerning the image based on a handwritten input applied through the display screen, comprising:
an editing mode designator for designating an editing mode from among a plurality of editing modes available for the handwritten input;
an executed position acquirer for acquiring an executed position on the display screen at which a particular handwriting operation is performed; and
a visual effect adder for adding a visual effect, which is temporarily displayed near the executed position acquired by the executed position acquirer, wherein the visual effect is added to a mode image representing the editing mode designated by the editing mode designator at a time that the particular handwriting operation is performed.

2. The image processing apparatus according to claim 1, further comprising a particular operation detector for detecting the particular handwriting operation.

3. The image processing apparatus according to claim 2, wherein upon display of an icon on the display screen for designating the editing mode, the particular operation detector effectively detects the particular handwriting operation within a region of the display screen from which the icon is excluded.

4. An image processing apparatus according to claim 1, wherein the visual effect adder adds the visual effect in order to change a displayed position of the mode image depending on a dominant hand of the user of the image processing apparatus.

5. An image processing apparatus according to claim 1, wherein the particular handwriting operation comprises any one of a single tap, a double tap, and a long tap.

6. An image processing apparatus according to claim 1, wherein the mode image includes a function to call up a pallet associated with the editing modes.

7. An image processing apparatus according to claim 1, wherein the mode image comprises an image that is identical or similar to an icon associated with the editing modes.

8. An image processing apparatus according to claim 1, wherein the mode image comprises an image including character information concerning a designated editing mode.

9. An image processing apparatus according to claim 1, wherein the image processing apparatus functions to enable proofreading of the image.

10. An information processing method adapted to be carried out by an apparatus having a display unit for displaying an image on a display screen, and a handwriting input unit for adding annotative information concerning the image based on a handwritten input applied through the display screen, comprising the steps of:
designating an editing mode from among a plurality of editing modes available for the handwritten input;
acquiring an executed position on the display screen at which a particular handwriting operation is performed; and
temporarily displaying, near the acquired executed position, a mode image representing the editing mode designated at a time that the particular handwriting operation is performed.

11. A storage medium storing a program therein, the program enabling an apparatus having a display unit for displaying an image on a display screen, and a handwriting input unit for adding annotative information concerning the image based on a handwritten input applied through the display screen, to function as:
an editing mode designator for designating an editing mode from among a plurality of editing modes available for the handwritten input;
an executed position acquirer for acquiring an executed position on the display screen at which a particular handwriting operation is performed; and
a visual effect adder for adding a visual effect, which is temporarily displayed near the executed position acquired by the executed position acquirer, wherein the visual effect is added to a mode image representing the editing mode designated by the editing mode designator at a time that the particular handwriting operation is performed.
